(19) United States
(12) Patent Application Publication
(10) Pub. No.: US 2013/0200815 A1
(43) Pub. Date: Aug. 8, 2013

(54) ENERGY STORAGE MEANS FOR LAST GASP / IMPEDANCE LIMITED APPLICATIONS

(71) Applicant: David Schie, San Jose, CA (US)

(72) Inventor: David Schie, San Jose, CA (US)

(21) Appl. No.: 13/366,567

(22) Filed: Feb. 6, 2012

(51) Int. Cl. G05F 3/08; H05B 37/02

(52) U.S. Cl. CPC G05F 3/08; H05B 37/02
USPC 315/224; 323/299

(57) ABSTRACT

A voltage converter is coupled to an input voltage for boosting the voltage to a much higher level so as to take advantage of smaller capacitors due to the quadratic energy equation ½*CV̂2. The voltage converter has at least one boost converter having an inductive element coupled to the input voltage. A high voltage storage element is coupled to the inductive element. A switching circuit of the at least one boost converter transfers stored electrical energy in the inductive element to said storage element. The switching circuit allows for the combining of the stored electric energy of the storage element with the input voltage to illuminate a flash element, or provide an increased amount of current temporarily to the input for applications such as last gasp.

### TECHNICAL FIELD

This application generally relates to electronics, and, more particularly, to a super capacitor replacement that takes advantage of the V² in ½CV², by storing energy on high voltage capacitors using a booster voltage converter and then making it available by either reversing the direction of said converter, making it a buck converter, to allow the charge to sum at the input with the battery charge source; or by coupling through a linear regulator directly to the element being powered.

### BACKGROUND

As cell phones and other portable electronic devices grow in complexity, manufacturers strive to include ever greater functionality in these devices to attract customers. For example, cell phones have incorporated video recorders, MP3 players, radios, and GPS systems. Small digital cameras have also been included with some cellular telephones. However, these cameras are not always used in situations where a sufficient amount of natural light is present to ensure a well exposed picture is taken. Additionally, solid state drives and batteries are being incorporated into these devices which are being relied upon for important data content. Unfortunately, when a battery is removed or power is taken away from these devices there is not enough time for these solid states drives or the processors and memory functions to cleanly store information and shutdown resulting in data loss or loss of operating continuity on the next startup. For this reason manufacturers are adding “last gasp” circuitry which stores energy using super capacitors (usually carbon capacitors) or large numbers of low voltage capacitors to provide enough time for these devices to finish their shutdown housekeeping. These solutions tend to be large and expensive. Rather than storing energy in this way, a switching supply is proposed which will store energy on smaller less expensive high voltage capacitors but still be able to convert the energy when needed to low voltage for use by said circuitry.

Electronic flashes are a simple and cheap method of providing proper lighting for photographic applications where the amount of natural light is limited. However, xenon flashes are expensive and high brightness LEDs have become the flash of choice for most phones. Unfortunately, the current required by these LEDs when combined with series impedance of batteries and instantaneous current demands of other systems such as processors, limits the available instantaneous current thus restricts the electronic flashes in portable electronic devices to a state inferior to that of stand alone cameras. A solution is to include a large number of capacitors, however, this tends to be expensive and takes up too much space in most designs. Additionally, the low impedance of so many capacitors can cause inrush and glitching problems. As such, there is a need for a mechanism to have available energy for use only when the flash is needed to overcome the impedance limitation.

One approach to overcome the above issues is the use of super capacitors. A super capacitor is an electrochemical capacitor that has an unusually high energy density when compared to common capacitors, typically on the order of thousands of times greater than a high capacity electrolytic capacitor. Unfortunately the development state of these capacitors is such that their range of temperature operation is limited to below that required by many application, their size continues to be large, they require inrush limiting circuitry due to their extremely low impedance, and their cost and availability is limited.

Therefore, it would be desirable to provide a circuit and method that overcomes the above problems.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a voltage converter coupled to an input voltage is disclosed comprising at least one booster converter having an inductive element coupled to the input voltage. A high voltage storage element is coupled to the inductive element. A switching circuit of the at least one boost converter transfers stored electrical energy in the inductive element to the storage element. The switching circuit is reversible, converting the at least one booster converter to a buck converter, returning the stored energy of the storage element to the input voltage to temporarily increase available current at an input terminal.

In accordance with another aspect of the present application, an energy storage means is disclosed comprising a switching converter coupled to an input voltage. A high voltage energy storage element is coupled to the switching converter; wherein the switching converter transfers energy from the low voltage input to be stored on the high voltage storage element until a signal requests a change in current direction and the switching converter then converters the energy stored at high voltage back to low voltage and makes it available to an input.

In accordance with another aspect of the present application, an energy storage means is disclosed comprising a wide conversion ratio two quadrant switching converter coupled to an input voltage. A high voltage energy storage element is coupled to the switching converter; wherein the switching converter transfers energy from a low voltage input to be stored on the high voltage storage element until a signal requests a change in current direction and the switching converter then converts the energy stored at high voltage back to low voltage and makes it available to the input

In accordance with another aspect of the present application, a switch mode power supply having an input terminal, an output terminal and a ground reference terminal, the switch mode power supply is disclosed comprising a first inductor having a first terminal and a second terminal, the first terminal of the first inductor coupled to the input terminal. A first switch having a first terminal and a second terminal is provided, the first terminal of the first switch coupled to the second terminal of the inductor. An interim capacitor having a first terminal and a second terminal is provided, the first terminal of the interim capacitor coupled to the second terminal of the first switch, the second terminal of the interim capacitor coupled to the ground reference terminal. A second inductor having a first terminal and a second terminal is provided, the first terminal coupled to the second terminal of the first switch and the first terminal of the interim capacitor. A second switch having a first terminal and a second terminal is provided, the first terminal of the second switch coupled to the second terminal of the second inductor. An output capacitor having a first terminal and a second terminal is provided, the first terminal of the output capacitor coupled to the second terminal of the second switch and the second terminal of the output capacitor coupled to the ground reference terminal. A third switch having a first terminal and a second terminal is provided, the first terminal of the third switch coupled to the second terminal of the second inductor and the first terminal of the second switch, the second terminal of the third switch coupled to the ground reference terminal. A first diode having an anode and a cathode is provided, the cathode of the first diode coupled to the second terminal of the second inductor, the first terminal of the second switch, and the first terminal of the third switch, the anode of the first diode coupled to the second terminal of the first inductor and the first terminal of the first switch, the output terminal coupled between the anode of the first diode and the second terminal of the first inductor and the first terminal of the first switch

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is an illustrative perspective view of a typical camera having a flash element and a capturing lens in accordance with one aspect of the present application;

FIG. 2 depicts an exemplary portable device having similar to features to the camera provided in FIG. 1 in accordance with one aspect of the present application;

FIG. 3 provides an exemplary internal configuration of a flash emission control section in accordance with one aspect of the present application;

FIG. 4 is a flow chart illustration exemplary processes performed by the converter in accordance with one aspect of the present application;

FIG. 5 illustrates a bi-directional quadratic converter in accordance with one aspect of the present application; and

FIG. 6 provides an example of bi-directional flow within the illustrative quadratic converter in accordance with one aspect of the present application.

### DESCRIPTION OF THE APPLICATION

The description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

Generally described, the present application relates to a supercapacitor replacement, and more particularly, to a circuit for boosting current to drive elements. In one illustrative embodiment, the supercapacitor replacement can include at least one boost converter coupled to an input voltage source. The at least one boost converter can boost electrical energy from the input voltage source and store the electrical energy in at least one storage element. The supercapacitor replacement can also include a switching circuit for reversing the direction of the stored electrical energy in the at least one storage element. The stored electric energy can be summed with the input voltage and be provided as output voltage.

As will be shown below, the supercapacitor replacement can include multiple variations and components that add to the embodiment provided above. The aforementioned should not be construed as limiting to the scope of the present application, but rather should be understood as one embodiment. Through the supercapacitor replacement, in the form of a bi-directional converter described herein, a more compact electrical energy delivery system can be provided within portable devices. The supercapacitor replacement can be used in a variety of applications including fast digital currents, backlights, graphics, haptic keypad presses, etc. One skilled in the relevant art will appreciate that the battery source impedance problem in portable devices is overcome through the supercapacitor replacement described within the present application.

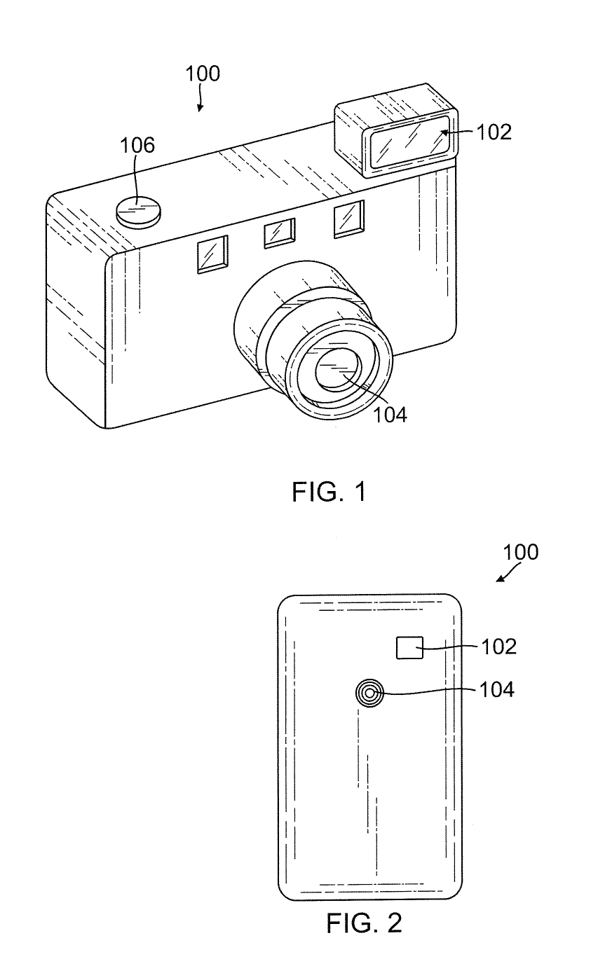

For purposes of illustration, the aforementioned circuit may be placed within a camera 100 as depicted in one embodiment in FIG. 1. One skilled in the relevant art will appreciate that the circuit disclosed within the present application is not limited to cameras 100. Instead, the circuit may typically be placed within electronic devices that use high current. In one embodiment, the circuit may store high voltages on an assembly such as a co-package QFN device.

FIG. 1 provides an external prospective view of one embodiment of the camera 100. The camera 100 may include a picture-taking lens 104. In addition, the camera 100 may include a flash emitting section 102, and as shown in FIG. 1, a protrusive formation on an upper portion of the camera 100.

To operate the camera 100, a release button 106 may be pushed by a user. When the release button 106 is pressed, light may be projected from the flash emitting section 102 towards an object. In some embodiments, the flash emitting section 102 may provide a delay period while the flash emitting section 102 stores enough electrical energy. While the light is projected, the picture-taking lens 104 may capture an image.

FIG. 2 depicts an exemplary camera 100 within a portable device having a flash emitting section 102 and picture taking lens 104 in accordance with one aspect of the present application. Such portable devices may include, but is not limited to, a personal digital assistant (PDA), handheld computer, mobile device, handheld device, smart phone, and mobile phone, to name a few. As shown, the portable device generally includes a smaller board on which components may be located.

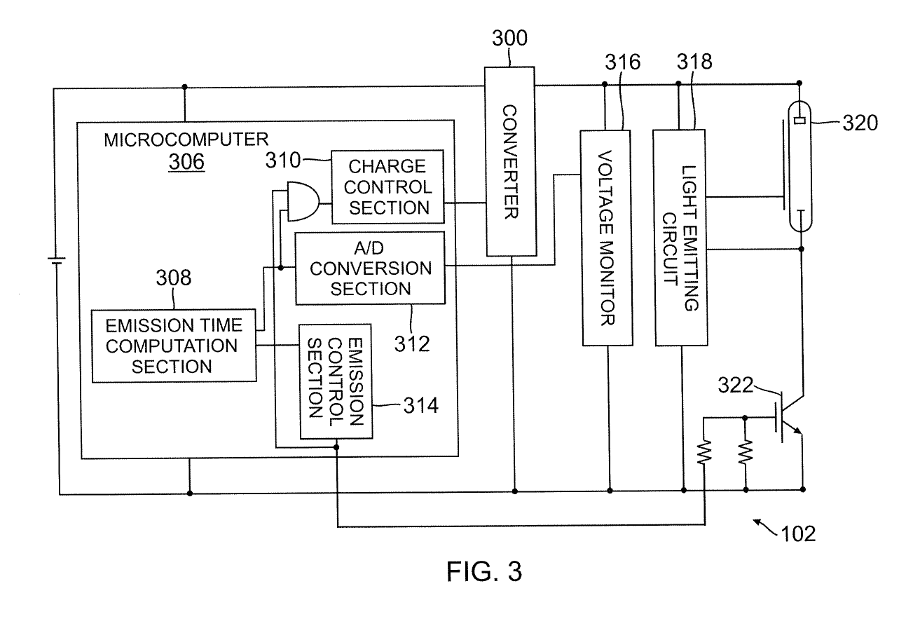

Referring to FIGS. 1-3, the flash emission section 102 may also include a converter 300, which generates and stores charge to send to the flash element 320 in one embodiment. The converter 300 may be a superconductor replacement. One skilled in the relevant art will appreciate that the converter 300 may be used in a variety of applications and the purpose of the previous illustration was to show one embodiment. More details of the converter 300 are shown below.

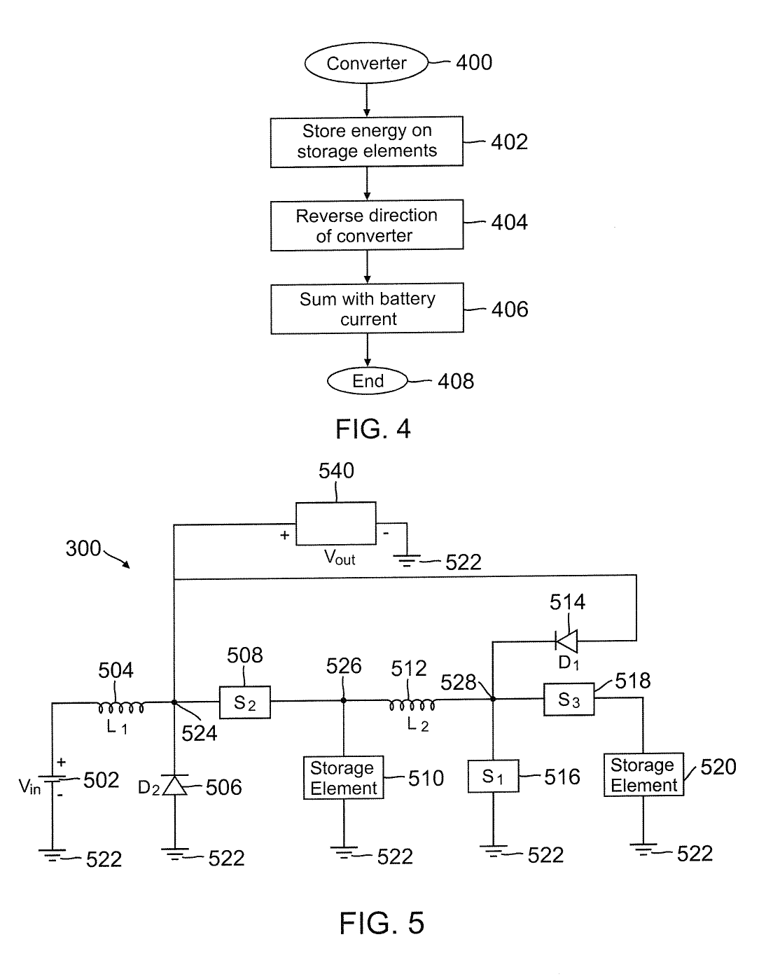

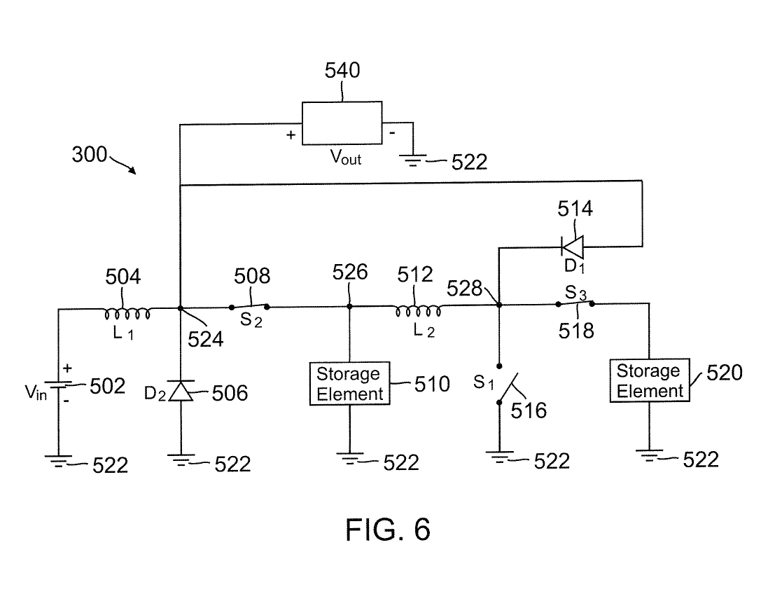

Before describing more details about converter 300, FIG. 4 provides a flow chart illustrating exemplary processes performed by the converter 300 in accordance with one aspect of the present application. The processes begin at block 400. At block 402, the converter 300 stores energy on storage elements. In one embodiment, the storage elements may include high voltage capacitors. Multiple storage elements may be used with the converter 300.

At block 404, the direction of the converter is reversed. The electrical energy which is released from the storage elements is then summed with the battery current at block 406 to drive a device such as a light emitting diode described or to provide current at the input when said battery is removed. The process ends at block 408.

With reference now to FIG. 5, the converter 300 will now be described, which may be used to drive multiple elements and is not limited to the camera 100 provided above. One skilled in the relevant art will appreciate that the converter 300 may be a supercapacitor replacement. In typical embodiments, the converter 300 may incorporate at least one boost converter with switches. In one configuration, the switches may allow the converter 300 to store electrical energy in the at least one storage element. In another configuration, the switches may allow the converter 300 to discharge the at least one storage element. When discharged, the electrical energy from the at least one storage element may combine with the input voltage to create a high output voltage, the output voltage capable of being converted into current. One skilled in the relevant art will appreciate that there are numerous embodiments and alternative implementations of the typical converter 300 described below which are within the scope of the present application.

As shown, the converter 300 may include dual inductors, inductor L₁ 504 and inductor L₂ 512. By using inductor L₁ 504 and inductor L₂ 512, a quadratic converter 300 may be formed. Nonetheless, the present application is not limited to quadratic converters 300, but may also encompass other circuits having converter units in series using multiple switches. In the alternative, converters 300 covered within the scope of the present application may also include multiple converter units in series operation with a single switching element. In essence, the converter 300 may draw electrical energy from an impedance limited supply over a period of time, and then discharge the electrical energy. Often, the time for drawing the electrical energy is longer compared to the discharge event.

With reference now to the specific embodiment provided in FIG. 5, the converter 300 may reduce space used on a printed circuit board which may provide a cost reduction. Furthermore, the converter 300 may introduce a critical conduction mode controller which utilizes soft switching to improve efficiency, eliminate the need for snubbers, and reduce component stress, therefore reduce rating requirements. The converter 300 may also reduce electromagnetic interference associated with hard switching with an appropriate critical or discontinuous mode control circuit.

As will become apparent from the description below, the converter 300 may store energy on a high voltage element, such as a capacitor. Capacitors store charge at a rate of ½cv². “c” is the constant capacitance defined as the ratio of charge on each conductor to the voltage between them. “v” is the voltage between each of the conductors. Thus, generally it is more efficient to increase the voltage on a capacitor than to increase the capacitance. In essence, the converter 300 is a supercapacitor replacement storing electrical energy on two high voltage elements to take advantage of the v² in the ½cv².

As shown in FIG. 5, a second order boost converter 300 may be modified to include in addition to an inductor L₁ 504, a switch S₂ 508 (which may include a body diode), and in addition to a storage element 510, an inductor L₂ 512, a switch S₁ 516, and a diode D₁ 514, an additional switch S₃ (which includes a body diode) 518, in series with said storage element 520 in the configuration as shown. By leaving S2 off and S3 off (if both contain a body diode) in booster configuration a second order booster is formed. But by switching S2, leaving S1 off and relying on its body diode, while switching S3 a second order buck is obtained from the high voltage storagte element 520 to said input. The input port of the quadratic converter 300 may be an input voltage source Vᵢₙ 502. One skilled in the relevant art will appreciate that the output terminal Vₒᵤₜ 540 may be coupled to a variety of different areas within the converter 300, but in the embodiment shown is coupled to the input voltage and a ground reference terminal 522 so that charge may be transferred from input 502 to storage element 520 or reversed to transfer charge from storage element 520 to the input 502 to temporarily increase the available current at the input. S2 or S3 may be used as synchronous diodes rather than relying upon their body diodes to save power at the price of additional switching control complexity. Said switching control may also optimize the high voltage switch transitions by soft switching in critical conduction mode.

In some embodiments, converter 300 diode D₂ 506 may be removed and S2 and S3 replaced with a diode. Diode D₂ 506 and switch S3 allow the converter 300 to operate in two quadrants (boost to storage element 520 and buck back to Vin). In this configuration another element, such as a regulator, coupled to storage element 520 must provide the voltage drop during the discharge period, or a high voltage device such as a piezo or xenon flash must be connected.

For purposes of illustrating the operations and features of the converter 300, a sequence in which electrical energy gets stored and discharged is presented. This sequence should, however, not be construed as limiting to the scope of the present application and should not be taken to infer any particular order. In one exemplary embodiment, each energy storage element can initially be discharged. To store electrical energy within storage element 510 and storage element 520, the voltage from Vᵢₙ 502 may go through inductor L₁ 504. When this occurs, the input voltage Vᵢₙ 502 may appear across the inductor L₁ 504, which causes a change in current flowing through inductor L₁ 504. The current for the inductor L₁ 504 can increase which typically results in electrical energy being stored within inductor L₁ 504.

A variety of switch combinations may be used to generate the above-desired effect. In order for the voltage from Vᵢₙ 502 to go through inductor L₁ 504 to the ground reference terminal 522, in one example, switch S₁ 516 can be turned on and switch S₂ 508 and switch S₃ 518 can be turned off. One skilled in the relevant art will appreciate that a variety of combinations may be provided for to increase the electrical energy being stored within inductor L₁ 504. Also, as described above, the switches provided in FIG. 5 should not be construed as limiting the scope of the present application.

Typically, storage element 510 can also discharge its stored energy into inductor L₂ 512 when L₁ 504 is storing electrical energy. In one embodiment, switch S₂ 508 and switch S₃ 518 may be turned off while switch S₁ 516 may be turned on to cause the electrical energy to flow from storage element 510 into inductor L₂ 512. One skilled in the relevant art will appreciate that there are numerous combinations of manipulating the switches so that this action may be performed. As shown, electrical energy may be stored in both inductor L₁ 504 and inductor L₂ 512.

In one embodiment, switch S₂ 508 and switch S₃ 518 may be turned on, while switch S₁ 516 may be turned off. Energy stored in inductor L1 504 will be transferred to storage element 510 and energy stored in 512 may be transferred to storage element 520. One skilled in the relevant art will appreciate that there are numerous combinations for storing energy in both storage element 510 and storage element 520. The switch logic provided above may continuously be used to introduce electrical energy to the storage elements 510 and 520 until the maximum threshold of energy is obtained taking advantage of the conversion ratio of 1/(1−D)², whereby D represents the duty cycle.

Another explanation in one embodiment is to consider that 502, 504, 508, 526, 514 and 516 represent a boost converter from 502 to 510. Capacitor 510, 512, 516 and 518 represent a boost converter from 510 to 520. This is a single switch quadratic or double boost configuration (1/(1−D)̂2). Now reversing operation, 520, 518, 516, 512, 516 and 510 represent a buck converter from 520 to 510, and 510, 508, 506, 504 and 502 represent a buck converter from 510 to 502. This is a D̂2 or double buck configuration if continuous. The second order transfer function increases the conduction angle to allow more power to be transferred with smaller peak currents.

In some embodiments, a linear element can drop the voltage from storage element 520 to a level compatible with a light emitting diode or other electric device while allowing charge to be converted to current. In other embodiments, storage element 510 and storage element 520 may be coupled to a high voltage flash element (such as xenon).

In some embodiments, soft switching may be introduced into converter 300 through diode D₂ 506. Soft-switching uses circuit resonance to ensure that power-transistors switch at or near or a zero voltage level. Normally, this reduces the stress on the components, and greatly reduces the high frequency energy that would otherwise be radiated as RF noise. Soft switching uses an appropriate switching sequence that allows the voltage across each transistor to swing near zero before the device turns on and current flows.

The converter 300 may be operated critically continuous at inductor L₁ 504 with soft switching determined at the voltage minimum on the cathode of the diode D₂ 506 during boost operation. For example, soft switching may be determined by differentiating the resonant voltage waveform to find the minima when the inductor L₁ 504 is resonating with the parasitics of components connected to said node.

As described above and shown in FIG. 2, the board space may be limited making the converter 300 provided within the present application valuable. In one embodiment, inductor L₁ 504 and inductor L₂ 512 may be created utilizing a combination of printed circuit board traces, chip scale package balls, and integrated circuit traces. Magnetic material may be mounted on the printed circuit board under the chip scale package to provide the magnetic core. In another embodiment, the converter 300 can be made using etching inductors into the integrated circuit itself.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A voltage converter coupled to an input voltage comprising:
at least one booster converter having an inductive element coupled to the input voltage;
a high voltage storage element coupled to the inductive element; and
a switching circuit of the at least one boost converter which transfers stored electrical energy in the inductive element to the storage element;
where said switching circuit is reversible, converting said at least one booster converter to a buck converter, returning the stored energy of the storage element to the input voltage to temporarily increase available current at an input terminal.

2. An energy storage means comprising:
a switching converter coupled to an input voltage;
a high voltage energy storage element coupled to the switching converter; wherein the switching converter transfers energy from the low voltage input to be stored on the high voltage storage element until a signal requests a change in current direction and the switching converter then converters the energy stored at high voltage back to low voltage and makes it available to an input.

3. An energy storage means comprising:
a wide conversion ratio two quadrant switching converter coupled to an input voltage;
a high voltage energy storage element coupled to the switching converter;
wherein the switching converter transfers energy from a low voltage input to be stored on the high voltage storage element until a signal requests a change in current direction and the switching converter then converts the energy stored at high voltage back to low voltage and makes it available to the input.

4. The energy storage means of claim 2 where said switching converter is one of: a single order buck boost, cuk or sepic converter.

5. The energy storage means of claim 3 where said two quadrant switching converter is a quadratic boost converted which switches to one of: a double buck, a buck-boost-buck, or a dual buck-boost converter.

6. The voltage converter of claim 1, further comprising a diode between the inductor and ground and a switch in series with said storage element allows second order bucking.

7. A voltage converter coupled to an input voltage for illuminating a flash element comprising:
at least one booster converter having an inductive element coupled to the input voltage;
a high voltage storage element coupled to the inductive element; and
wherein a switching circuit of the at least one boost converter transfers stored electrical energy in the inductive element to the storage element;
a regulating circuit combining the stored electrical energy of the storage element with the input voltage and to illuminate the flash element or directly through the regulating circuit to said flash element;

8. The energy storage means of claim 2, further comprising a detector means coupled to the energy storage means, wherein loss of input power triggers a reversal of energy from the high voltage storage element to the input to provide a power source long enough to allow one of: housekeeping or shutdown after battery removal from battery powered equipment.

9. The energy storage means of claim 2, wherein the energy storage unit is used for last gasp energy holdup in solid state drives to allow one of: housekeeping or shutdown after power removal to ensure integrity of data.

10. The voltage converter of claim 1, further comprising a control circuit forcing critical operation to allow soft switching.

11. The voltage converter of claim 1 further comprising a plurality of boost stages.

12. The energy storage means of claim 2 or 3, wherein said high voltage storage element is a capacitive element.

13. A circuit comprising:
a first inductor and a first diode and a first storage element connected to said first inductor, wherein said first storage element is connected to said first inductor stores charge, said first inductor receiving an input voltage;
a second inductor and a second diode and a second storage element connected to said second inductor, wherein said second storage element connected to said second inductor stores charge;
at least one switch element allowing said circuit to charge said first storage element connected to said first inductor and said second storage connected to said second inductor, said at least one switch element further allowing discharge of said first storage element connected to said first inductor and said second storage element connected to said second inductor to produce an output voltage.

14. The voltage converter of claim 7, wherein said flash element is a light emitting diode.

15. The circuit of claim 13, wherein one of a haptic or piezo element is coupled to said output voltage.

16. The circuit of claim 13, wherein said first storage element and said second storage element are capacitive elements.

17. A switch mode power supply having an input terminal, an output terminal and a ground reference terminal, the switch mode power supply comprising:
a first inductor having a first terminal and a second terminal, said first terminal of said first inductor coupled to said input terminal;
a first switch having a first terminal and a second terminal, said first terminal of said first switch coupled to said second terminal of said inductor;
an interim capacitor having a first terminal and a second terminal, said first terminal of said interim capacitor coupled to said second terminal of said first switch, said second terminal of said interim capacitor coupled to said ground reference terminal;
a second inductor having a first terminal and a second terminal, said first terminal coupled to said second terminal of said first switch and said first terminal of said interim capacitor;
a second switch having an first terminal and a second terminal, said first terminal of said second switch coupled to said second terminal of said second inductor;
an output capacitor having a first terminal and a second terminal, said first terminal of said output capacitor coupled to said second terminal of said second switch and said second terminal of said output capacitor coupled to said ground reference terminal;
a third switch having a first terminal and a second terminal, said first terminal of said third switch coupled to said second terminal of said second inductor and said first terminal of said second switch, said second terminal of said third switch coupled to said ground reference terminal; and
a first diode having an anode and a cathode, said cathode of said first diode coupled to said second terminal of said second inductor, said first terminal of said second switch, and said first terminal of said third switch, said anode of said first diode coupled to said second terminal of said first inductor and said first terminal of said first switch, said output terminal coupled between said anode of said first diode and said second terminal of said first inductor and said first terminal of said first switch.

18. The switch mode power supply of claim 17, further comprising a second diode having an anode and cathode, said cathode of said second diode coupled to said second terminal of said first inductor, said anode of said first diode, and said first terminal of said first switch, wherein said second diode anode is connected to ground to allow bucking from said first storage element to said input terminal.

19. The switch mode power supply of claim 17, wherein said first capacitor, said second capacitor, and said input terminal provide an output voltage to said output terminal.

20. The switch mode power supply of claim 17, wherein said first inductor and said second inductor are created using PCB traces.

21. The switch mode power supply of claim r 17, where passive elements are incorporated on one of a silicon or 3-5 material substrate.

22. The switch mode power supply of claim 17, where said first diode and said first, second and third switches are fabricated using GaN.

23. The switch mode power supply of claim 17, wherein said switch mode power supply is incorporated into a single multi-chip module (MCM).

24. The voltage converter of claim 1, wherein said inductor element is created using PCB traces.

25. The voltage converter of claim 1, wherein passive elements are incorporated on one of a silicon or 3-5 material substrate.

26. The voltage converter of claim 6, where said diode is fabricated using GaN.

27. The voltage converter of claim 1, wherein said voltage converter is incorporated into a single multi-chip module (MCM).
